(19) United States
(12) Patent Application Publication
(10) Pub. No.: US 2012/0032856 A1
(43) Pub. Date: Feb. 9, 2012

(54) PLANAR ANTENNA

(75) Inventors: GUO-LUN HUANG, Hsinchu County (TW); Chih-Ming Wang, Hsinchu County (TW)

(73) Assignee: Wistron NeWeb Corp., Hsinchu County (TW)

(21) Appl. No.: 12/977,186

(22) Filed: Dec. 23, 2010

(30) Foreign Application Priority Data
Aug. 4, 2010 (TW) 099214905

(51) Int. Cl. H01Q 9/04

(52) U.S. Cl. 343/700 MS

(57) ABSTRACT

A planar antenna includes a grounding part, a first radiator arm and a second radiator arm. The first radiator arm is spaced apart from the grounding part, and includes a first coupling section and a feed-in end. The second radiator arm includes an extension section and a second coupling section. The extension section has one end connected to the grounding part, and further has another end connected to the second coupling section. The first coupling section extends in a first direction substantially perpendicular to a second direction in which the second coupling section extends. The first coupling section is spaced apart from the second coupling section such that signals transmitted through the first coupling section may be coupled to the second coupling section.

### CROSS-REFERENCE TO RELATED APPLICATION

This application claims priority of Taiwanese Application No. 099214905, filed on Aug. 4, 2010.

### BACKGROUND OF THE INVENTION

1. Field of the Invention

The present invention relates to a planar antenna, more particularly to a planar antenna with transverse coupling.

2. Description of the Related Art

Planar inverted-F antenna (PIFA) has advantages of being flat, lightweight, etc., and is therefore suitable for mobile phones, Bluetooth devices, radio frequency devices and so on.

Referring to FIG. 1, Taiwanese Patent No. 1318021 discloses a broadband planar antenna 900, wherein a coupling conductor 920 is fed with signals from a feed-in line 910, and signals may be coupled to an extension conductor 930 adjacent to the coupling conductor 920 for resonation in a high frequency band. However, there is longitudinal coupling between the coupling conductor 920 and the extension conductor 930, i.e., extension direction and coupling direction of the coupling conductor 920 and the extension conductor 930 are substantially parallel, such that a length of the coupling conductor 920 may directly affect coupling amount of signals coupled to the extension conductor 930 (under the condition that a gap between the coupling conductor 920 and the extension conductor 930 is kept the same). Thus, when designers want to modify the length of the coupling conductor 920 according to different usage demands, the coupling amount between the coupling conductor 920 and the extension conductor 930 may be undesirably changed therewith so that the bandwidth of the broadband planar antenna 900 is not easy to control.

### SUMMARY OF THE INVENTION

Therefore, an object of the present invention is to provide a planar antenna with increased bandwidth and easily-configured operation mode.

Accordingly, a planar antenna of the present invention is to be laid out on a circuit board, and includes a grounding part, a first radiator arm and a second radiator arm. The first radiator arm is spaced apart from the grounding part, and includes a first coupling section and a feed-in end. The second radiator arm includes an extension section and a second coupling section. The extension section has one end connected to the grounding part, and further has another end connected to the second coupling section. The first coupling section extends in a first direction substantially perpendicular to a second direction in which the second coupling section extends. The first coupling section is spaced apart from the second coupling section such that signals transmitted through the first coupling section may be coupled to the second coupling section. In this way, when length of the first radiator arm or the second radiator arm is changed, coupling amount between the first radiator arm and the second radiator arm may be kept the same to facilitate configuration of the operating frequency band of the planar antenna.

Preferably, the first radiator arm further includes a first arm section, a second arm section, and a third arm section. The first arm section is spaced apart from the grounding part, and has one end which is adjacent to the grounding part and which serves as the feed-in end. The first arm section extends in the first direction. The second arm section has one end connected to another end of the first arm section opposite to the feed-in end, and extends in the second direction. The first coupling section has one end connected to another end of the second arm section opposite to the first arm section, and extends in the first direction. The third arm section has one end connected to another end of the first coupling section opposite to the second arm section, and extends in the second direction. Therefore, amount of transverse coupling between the first coupling section and the second coupling section is unaffected by a change in the length of any one of the first arm section, the second arm section, the third arm section, and the first coupling section. Thus, it is easier to configure the operating frequency band of the planar antenna.

### BRIEF DESCRIPTION OF THE DRAWINGS

Other features and advantages of the present invention will become apparent in the following detailed description of the five preferred embodiments with reference to the accompanying drawings, of which:

FIG. 1 illustrates a conventional broadband planar antenna;

FIG. 2 illustrates a first preferred embodiment of the planar antenna of the present invention;

FIG. 3 illustrates actual dimensions of the planar antenna of the first preferred embodiment;

FIG. 4 illustrates that a first radiator arm of the first preferred embodiment may resonate in a first frequency band, wherein arrows in FIG. 4 indicate a transmission direction of input signals;

FIG. 5 illustrates that a second radiator arm of the first preferred embodiment may resonate in a second frequency band, wherein arrows in FIG. 5 indicate another transmission direction of the input signals;

FIG. 6 illustrates a Voltage Standing Wave Ratio plot (VSWR) of the planar antenna of the first preferred embodiment;

FIG. 7 illustrates a second preferred embodiment of the planar antenna of the present invention;

FIG. 8 illustrates a VSWR plot of the planar antenna of the second preferred embodiment;

FIG. 9 illustrates a third preferred embodiment of the planar antenna of the present invention;

FIG. 10 illustrates a VSWR plot of the planar antenna of the third preferred embodiment;

FIG. 11 illustrates a fourth preferred embodiment of the planar antenna of the present invention;

FIG. 12 illustrates a VSWR plot of the planar antenna of the fourth preferred embodiment;

FIG. 13 illustrates a fifth preferred embodiment of the planar antenna of the present invention;

FIG. 14 illustrates a first surface of a circuit board of the fifth preferred embodiment, wherein a second radiator arm and a third coupling section are laid out thereon;

FIG. 15 illustrates a second surface of the circuit board of the fifth preferred embodiment, wherein a first arm section, a second arm section, a first coupling section and a third arm section are laid out thereon; and

FIG. 16 illustrates a VSWR plot of the planar antenna of the fifth preferred embodiment.

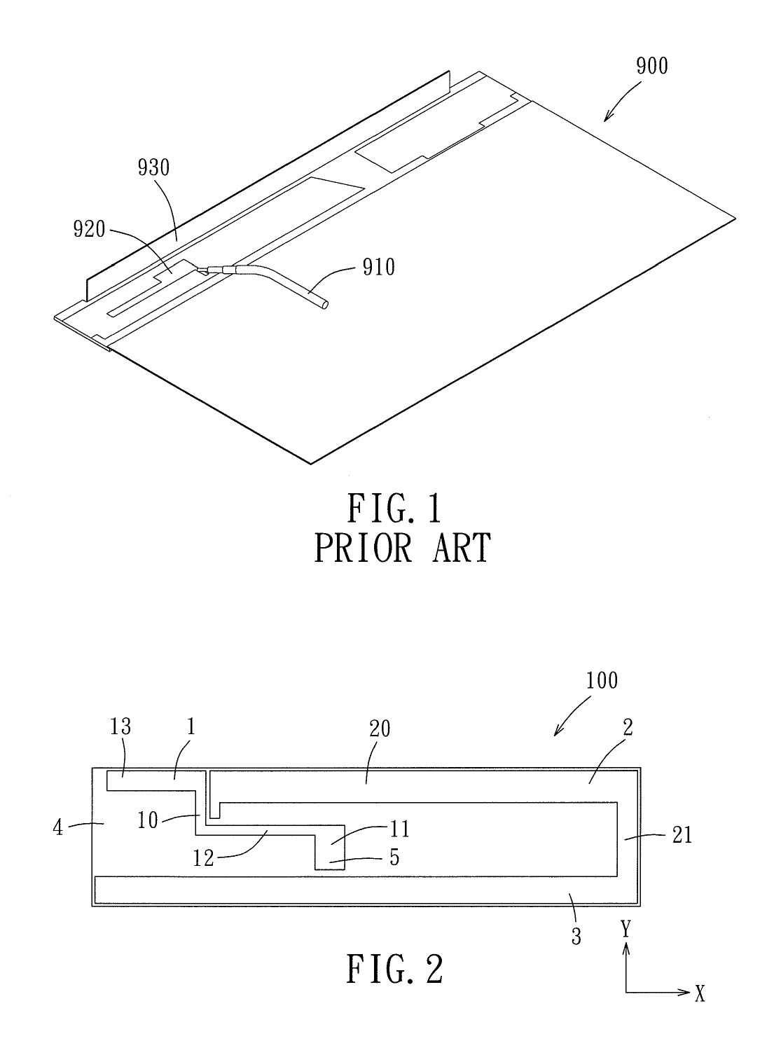

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

Referring to FIG. 2, a first preferred embodiment of a planar antenna 100 of the present invention is illustrated. The planar antenna 100 is laid out on one surface of a printed circuit board (PCB) 4, and includes a first radiator arm 1, a second radiator arm 2 and a grounding part 3. An extension direction of at least a portion of the first radiator arm 1 is substantially transverse to an extension direction of at least a portion of the second radiator arm 2, such that signals transmitted through the first radiator arm 1 may be coupled transversely to the second radiator arm 2 for achieving an effect of increased bandwidth.

The first radiator arm 1 includes a first arm section 11, a second arm section 12, a first coupling section 10, and a third arm section 13. The first arm section 11 is spaced apart from the grounding part 3, and extends in a first direction (Y-axis direction). The first arm section 11 has one end which is adjacent to the grounding part 3 and which serves as a feed-in end 5. The second arm section 12 has one end connected to another end of the first arm section 11 distal from the grounding part 3 (i.e., another end of the first arm section 11 opposite to the feed-in end 5), and extends in a second direction (X-axis direction). The first direction is substantially perpendicular to the second direction.

The first coupling section 10 has one end connected to another end of the second arm section 12 opposite to the first arm section 11, and extends in the first direction. The third arm section 13 has one end connected to another end of the first coupling section 10 opposite to the second arm section 12, and extends in the second direction. The third arm section 13 is laid out at a long side of the PCB 4. In this embodiment, an overall length of the first coupling section 10 and the third arm section 13 is greater than that of the first arm section 11 and the second arm section 12, but is not limited to the disclosure of this embodiment.

The second radiator arm 2 includes an extension section 21 and a second coupling section 20. The extension section 21 has one end connected to the grounding part 3, and extends in the first direction. The extension section 21 is laid out at a short side of the PCB 4. The second coupling section 20 has one end connected to another end of the extension section 21 opposite to the grounding part 3, and extends in the second direction. In this embodiment, an extension direction (second direction) of the second coupling section 20 is transverse to that (first direction) of the first coupling section 10, and the second coupling section 20 has another end, which is opposite to the extension section 21, spaced apart from the first coupling section 10 by a predefined gap so that signals transmitted through the first coupling section 10 may be coupled to the second coupling section 20.

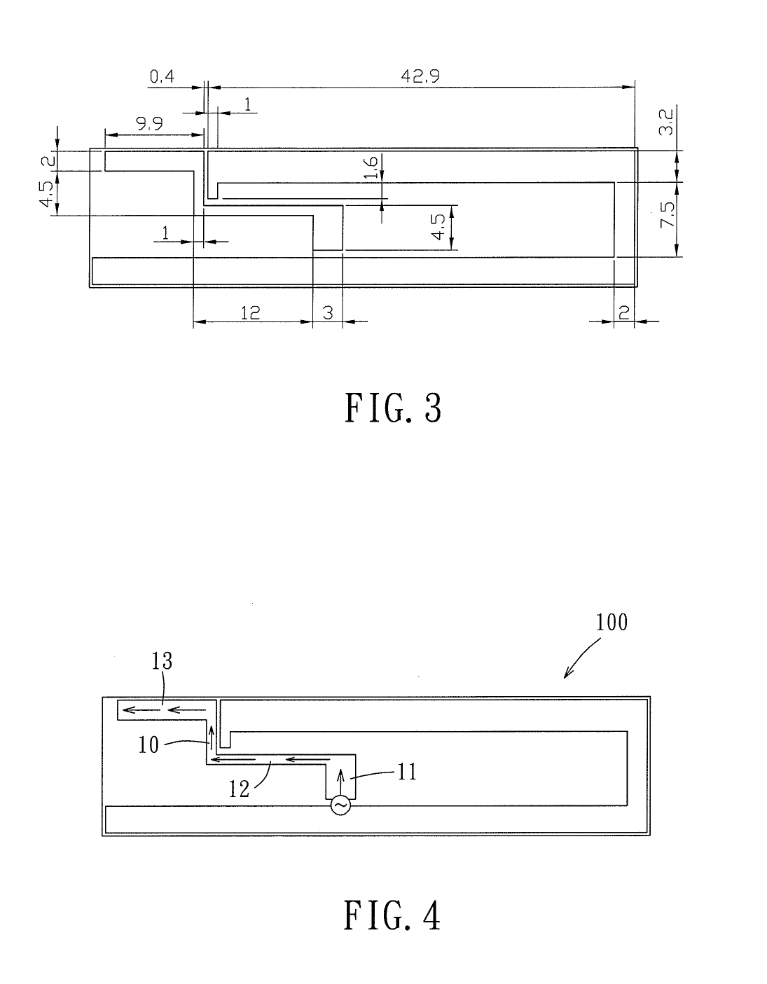

Referring to FIG. 3, actual dimensions of the planar antenna 100 of this embodiment are illustrated. Units of numerals in FIG. 3 are in millimeters (mm). A minimum gap between the first coupling section 10 and the second coupling section 20 is smaller than 3 mm (in this embodiment, it is 0.4 mm). Moreover, dimensions of the first radiator arm 1, the second radiator arm 2 and the grounding part 3 are not limited to the disclosure of this embodiment, and may vary according to different demands.

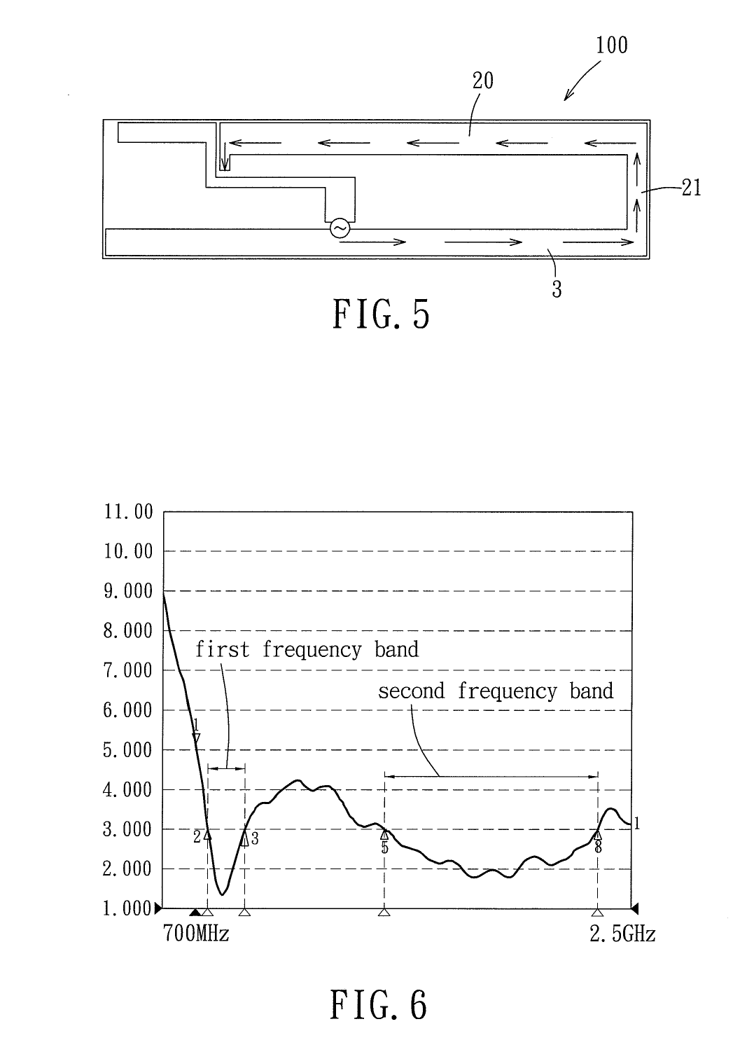

Referring to FIG. 4 and FIG. 5, the planar antenna 100 of this embodiment may resonate in a first frequency band (low frequency) through a first electric current path (FIG. 4) formed by the first radiator arm 1 (the first arm section 11, the second arm section 12, the first coupling section 10 and the third arm section 13), and may further resonate in a second frequency band (high frequency) through a second electric current path (FIG. 5) formed by the second radiator arm 2 (the extension section 21 and the second coupling section 20) for receiving and radiating signals in the corresponding frequency bands. Specifically, since the first coupling section 10 and the second coupling section 20 are spaced apart from each other, signals transmitted through the first coupling section 10 may be coupled to the second coupling section 20 for increasing a bandwidth of the first frequency band (low frequency). Furthermore, the extension direction of the first coupling section 10 is transverse to that of the second coupling section 20 so that the first coupling section 10 and the second coupling section 20 are coupled transversely with each other. Therefore, an amount of transverse coupling between the first coupling section 10 and the second coupling section 20 is unaffected by a change in the length of any one of the first arm section 11, the second arm section 12, the third arm section 13, and the first coupling section 10. Thus, it is easier to configure the operation mode of the planar antenna 100.

Referring to FIG. 6, a voltage standing wave ratio (VSWR) plot of the planar antenna 100 of this preferred embodiment is illustrated. It is apparent from the plot that the VSWR values of the planar antenna 100 are smaller than 3 in the first frequency band and the second frequency band, thus satisfying usage demands.

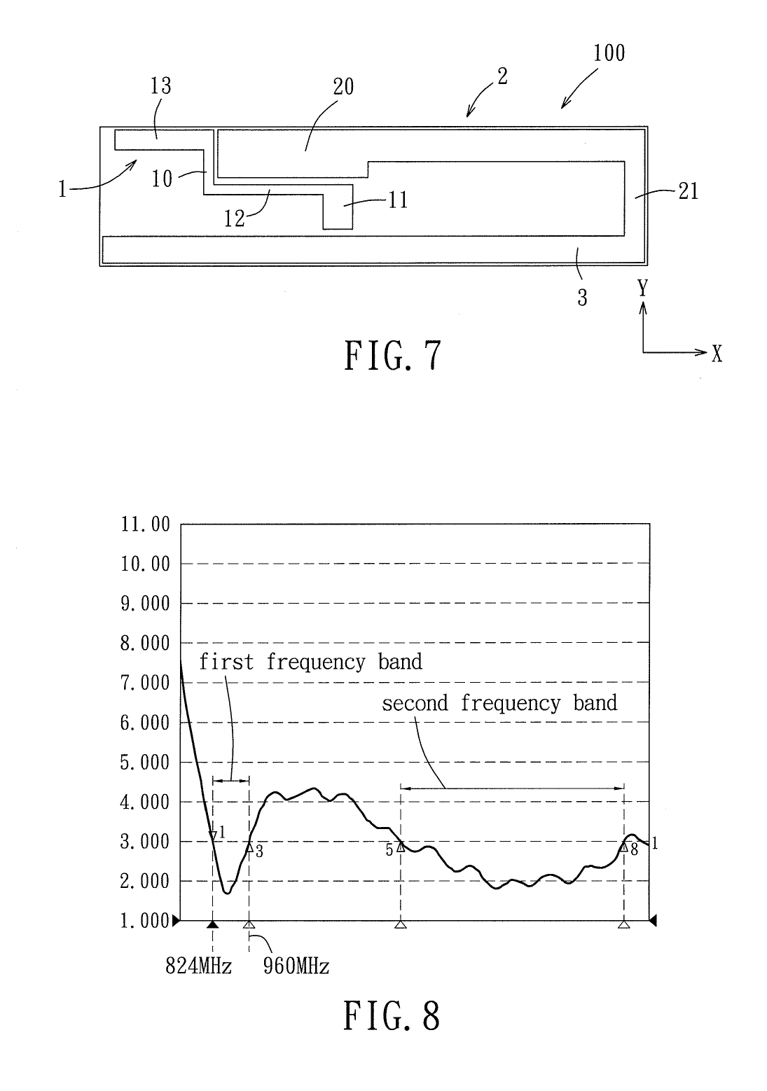

Referring to FIG. 7, a second preferred embodiment of the planar antenna 100 of the present invention is illustrated, which is substantially similar to the first embodiment. The differences reside in that the end of the second coupling section 20 of the second radiator arm 2 which is opposite to the extension section 21 further extends in the first direction such that a gap between said end of the second coupling section 20 and the second arm section 12 of the first radiator arm 1 is smaller than that in the first preferred embodiment. Thus, signals may not only be coupled transversely to the second coupling section 20 when transmitted through the first coupling section 10 but may also be coupled longitudinally to the second coupling section 20 when transmitted through the second arm section 12. In this way, aside from permitting configuration of the operation mode of the planar antenna 100, radiation efficiency at the first frequency band may be increased.

Referring to FIG. 8, a VSWR plot of the planar antenna 100 of this embodiment is illustrated. It is apparent from the plot that an operation band of the first frequency band satisfies usage demands in a frequency band ranging from 824 MHz to 960 MHz.

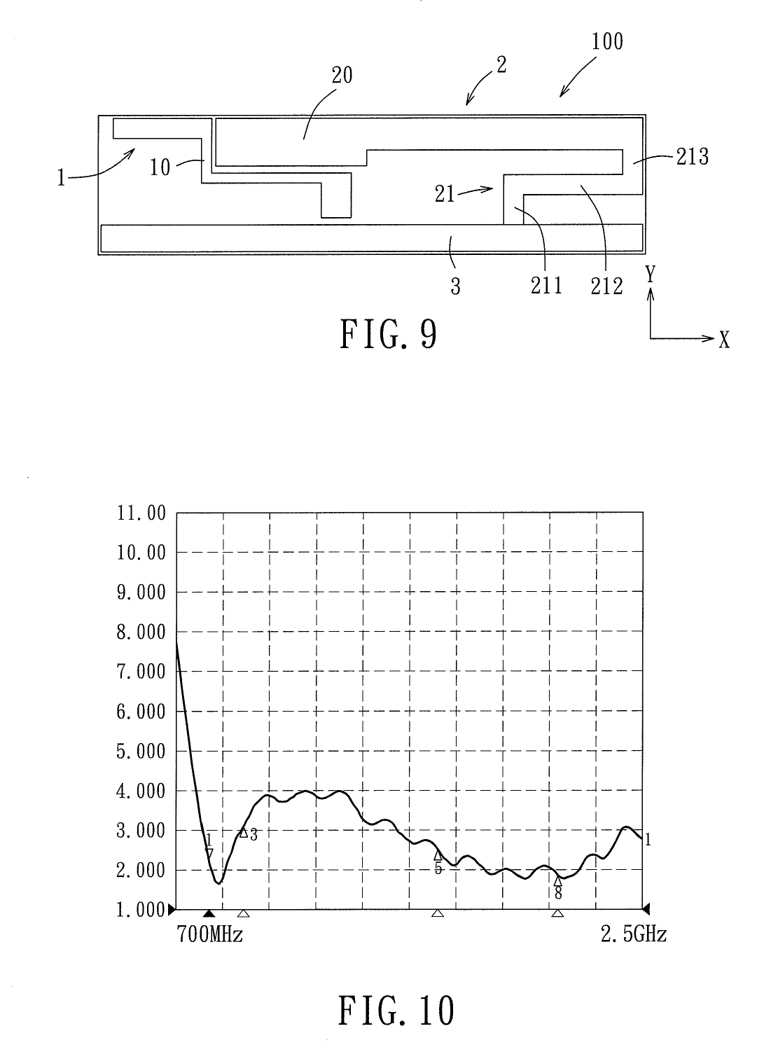

Referring to FIG. 9, a third preferred embodiment of the planar antenna 100 of the present invention is illustrated, which is substantially similar to the second embodiment. The differences reside in that the extension section 21 of the second radiator arm 2 includes a first segment 211, a second segment 212, and a third segment 213. The first segment 211 has one end connected to the grounding part 3, and extends in the first direction. The second segment 212 has one end connected to another end of the first segment 211 opposite to the grounding part 3, and extends in the second direction. The third segment 213 has two ends each connected to a respective one of another end of the second segment 212 opposite to the first segment 211 and one end of the second coupling section 20 distal from the first coupling section 10. The third segment 213 extends in the first direction. Thus, a length of the second radiator arm 2 may be varied to satisfy demands for operating in different frequency bands. Specifically, in this embodiment, an amount of transverse coupling between the first coupling section 10 and the second coupling section 20 is kept the same for achieving an effect of easily-configurable operation mode of the present invention, even though the length of the second radiator arm 2 has been changed to meet different demands. Referring to FIG. 10, a VSWR plot of the planar antenna 100 of this embodiment is illustrated.

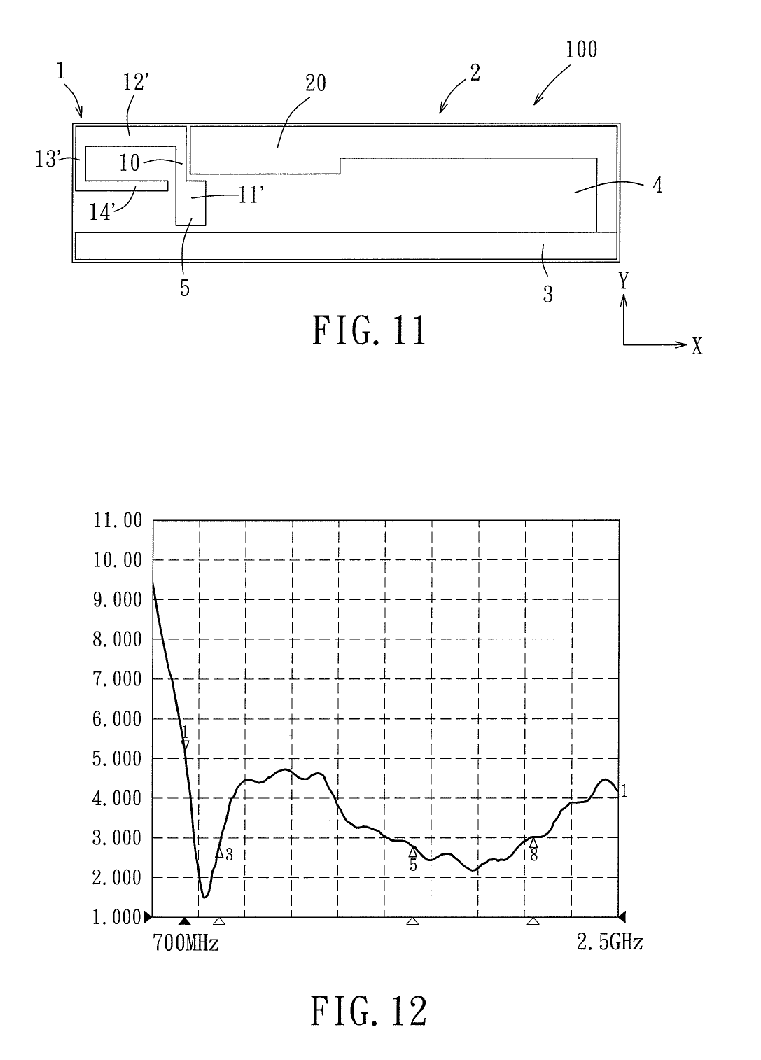

Referring to FIG. 11, a fourth preferred embodiment of the planar antenna 100 of this invention is illustrated. In this embodiment, the first radiator arm 1 includes a first arm section 11′, a first coupling section 10, a second arm section 12′, a third arm section 13′, and a fourth arm section 14′.

The first arm section 11′ is spaced apart from the grounding part 3, has one end which is adjacent to the grounding part 3 and which serves as the feed-in end 5, and extends in the first direction. The first coupling section 10 has one end connected to another end of the first arm section 11′ opposite to the feed-in end 5, and extends in the first direction. The second arm section 12′ has one end connected to another end of the first coupling section 10 opposite to the first arm section 11′, and extends in the second direction. The third arm section 13′ has one end connected to another end of the second arm section 12′ opposite to the first coupling section 10, and extends in the first direction. The fourth arm section 14′ has one end connected to another end of the third arm section 13′ opposite to the second arm section 12′, and extends in the second direction. The fourth arm section 14′ has another end spaced apart from the first arm section 11′. In this embodiment, the second arm section 12′ and the third arm section 13′ are respectively laid out at the long side and another short side of the PCB 4. Similarly, an amount of transverse coupling between the first coupling section 10 and the second coupling section 20 may be kept the same for achieving an effect of easily-configurable operation mode of the planar antenna 100 of the present invention, even though a length of the first radiator arm 1 has been changed to meet different demands. Referring to FIG. 12, a VSWR plot of the planar antenna 100 of this embodiment is illustrated.

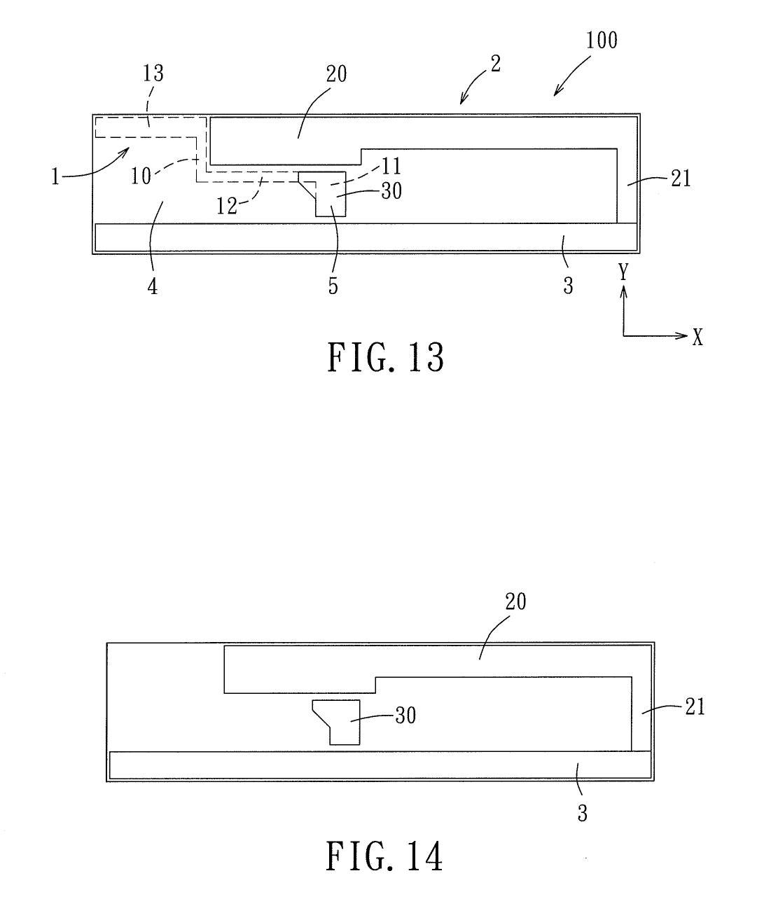

Referring to FIG. 13, a fifth preferred embodiment of the planar antenna 100 of the present invention is illustrated, which is substantially similar to the second embodiment. The differences reside in that aside from a first arm section 11, a second arm section 12, a first coupling section 10 and a third arm section 13, the first radiator arm 1 of this embodiment further includes a third coupling section 30.

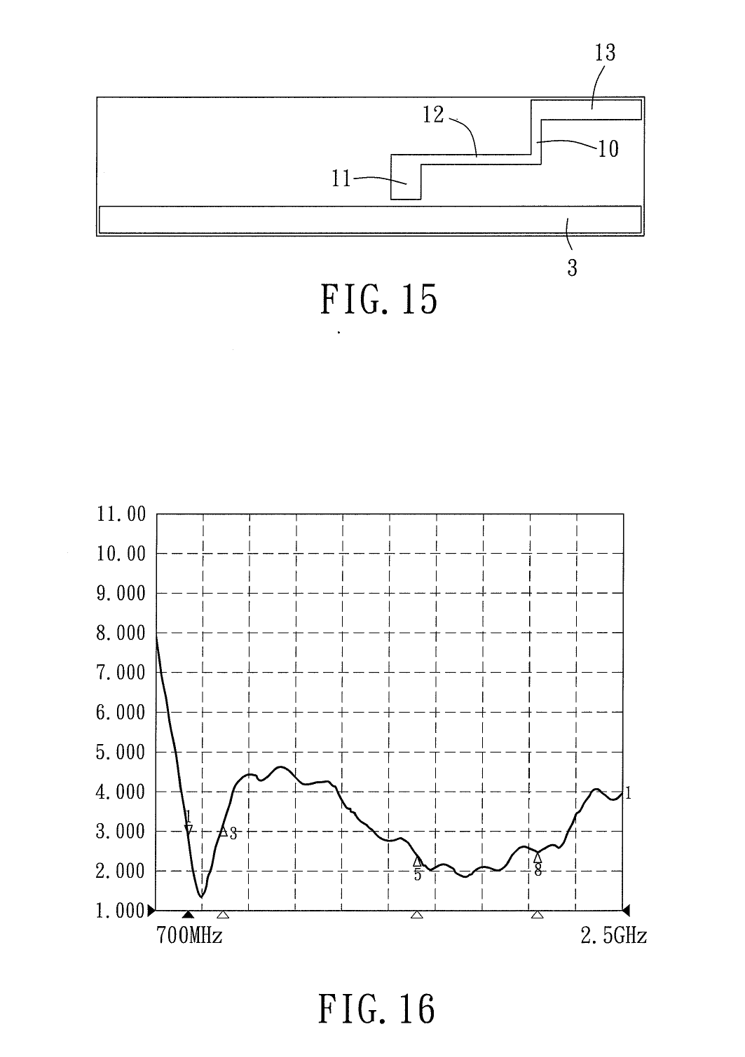

Referring to FIG. 14 and FIG. 15, the third coupling section 30 of the first radiator arm 1 is laid out on a first surface of the PCB 4. The first arm section 11, the second arm section 12, the first coupling section 10 and the third arm section 13 are laid out on a second surface (opposite to the first surface on which the third coupling section 30 is laid out) of the PCB 4, and connecting relations thereby are the same as those in the second preferred embodiment. Thus, further details of the same are omitted herein for the sake of brevity.

The second radiator arm 2 includes an extension section 21 and a second coupling section 20, and connecting relation therebetween is the same as that in the second preferred embodiment.

The third coupling section 30 is disposed between the second coupling section 20 and the grounding part 3, and is spaced apart from the second coupling section 20 and the grounding part 3. The third coupling section 30 has one end, which is adjacent to the grounding part 3 and which serves as the feed-in end 5 of the planar antenna 100 of this preferred embodiment. While the third coupling section 30 overlaps with a projection of the first arm section 11 onto the first surface completely and with a portion of a projection of the second arm section 12 onto the first surface, the present invention is not limited in this respect as long as the third coupling section 30 overlaps with at least a portion of the projection of the first arm section 11 onto the first surface.

When the feed-in end 5 is fed with signals, the signals transmitted through the third coupling section 30 may be coupled to the first arm section 11, and transmitted to the third arm section 13 via the second arm section 12 and the first coupling section 10 so as to resonate in the first frequency band. Specifically, signals transmitted through the first coupling section 10 may be coupled to the second coupling section 20 with the same amount of transverse coupling for increasing the bandwidth of the first frequency band. Thus, the effect of easily-configurable operation mode of the planar antenna 100 of the present invention may be likewise achieved. Referring to FIG. 16, a VSWR plot of the planar antenna 100 of this embodiment is illustrated.

In summary, an operation bandwidth of the planar antenna 100 of the present invention may be increased by virtue of the extension direction of at least a portion of the first radiator arm 1 being substantially transverse to the extension direction of at least a portion of the second radiator arm 2, such that signals transmitted through the first radiator arm 1 may be coupled transversely to the second radiator arm 2. Moreover, the amount of transverse coupling between the first coupling section 10 and the second coupling section 20 is unaffected by a change in the lengths of the first coupling section 10 and the second coupling section 20. Thus, it is easier to configure the operation mode of the planar antenna 100.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A planar antenna to be laid out on a circuit board, said planar antenna comprising:
a grounding part;
a first radiator arm being spaced apart from said grounding part, and including a first coupling section and a feed-in end; and
a second radiator arm including an extension section and a second coupling section, said extension section having one end connected to said grounding part, and further having another end connected to said second coupling section, said first coupling section extending in a first direction substantially perpendicular to a second direction in which said second coupling section extends, said first coupling section being spaced apart from said second coupling section such that signals transmitted through said first coupling section may be coupled to said second coupling section.

2. The planar antenna as claimed in claim 1, wherein said first radiator arm further includes a first arm section, a second arm section and a third arm section,
said first arm section being spaced apart from said grounding part, having one end which is adjacent to said grounding part and which serves as said feed-in end, and extending in the first direction,
said second arm section having one end connected to another end of said first arm section opposite to said feed-in end, and extending in the second direction,
said first coupling section having one end connected to another end of said second arm section opposite to said first arm section, and extending in the first direction,
said third arm section having one end connected to another end of said first coupling section opposite to said second arm section, and extending in the second direction.

3. The planar antenna as claimed in claim 2, wherein said second coupling section has one end opposite to said extension section which further extends in the first direction and which is spaced apart from said second arm section, such that signals transmitted through said second arm section may be coupled to said second coupling section.

4. The planar antenna as claimed in claim 3, wherein said extension section includes a first segment, a second segment and a third segment,
said first segment having one end connected to said grounding part and extending in the first direction,
said second segment having one end connected to another end of said first segment opposite to said grounding part, and extending in the second direction,
said third segment having two ends each connected to a respective one of said second coupling section and another end of said second segment opposite to said first segment, said third segment extending in the first direction.

5. The planar antenna as claimed in claim 1, wherein said extension section includes a first segment, a second segment and a third segment,
said first segment having one end connected to said grounding part and extending in the first direction,
said second segment having one end connected to another end of said first segment opposite to said grounding part, and extending in the second direction,
said third segment having two ends each connected to a respective one of said second coupling section and another end of said second segment opposite to said first segment, said third segment extending in the first direction.

6. The planar antenna as claimed in claim 1, wherein said first radiator arm further includes a first arm section, a second arm section, a third arm section, and a fourth arm section,
said first arm section being spaced apart from said grounding part, having one end which is adjacent to said grounding part and which serves as said feed-in end, and extending in the first direction,
said first coupling section having one end connected to another end of said first arm section opposite to said feed-in end, and extending in the first direction,
said second arm section having one end connected to another end of said first coupling section opposite to said first arm section, and extending in the second direction,
said third arm section having one end connected to another end of said second arm section opposite to said first coupling section, and extending in the first direction,
said fourth arm section having one end connected to another end of said third arm section opposite to said second arm section, and extending in the second direction.

7. The planar antenna as claimed in claim 1, wherein said grounding part, said first radiator arm and said second radiator arm are to be laid out on the same surface of the circuit board.

8. The planar antenna as claimed in claim 1, wherein said first radiator arm further includes a first arm section, a second arm section, a third arm section and a third coupling section,
said third coupling section and said second radiator arm are to be disposed on a first surface of the circuit board,
said first arm section, said second arm section, said third arm section and said first coupling section are to be disposed on a second surface of the circuit board opposite to the first surface,
said third coupling section has one end, which is spaced apart from and adjacent to said grounding part and which serves as said feed-in end,
said third coupling section overlaps with at least a portion of a projection of said first arm section onto the first surface,
said first arm section extends in the first direction,
said second arm section has one end connected to an end of said first arm section, and extends in the second direction,
said first coupling section has one end connected to another end of said second arm section opposite to said first arm section, and extends in the first direction, and
said third arm section has one end connected to another end of said first coupling section opposite to said second arm section, and extends in the second direction.

9. The planar antenna as claimed in claim 8, wherein said extension section of said second radiator arm extends in the first direction, and said second coupling section extends in the second direction.

10. The planar antenna as claimed in claim 6, wherein said extension section of said second radiator arm extends in the first direction, and said second coupling section extends in the second direction.

11. The planar antenna as claimed in claim 2, wherein said extension section of said second radiator arm extends in the first direction, and said second coupling section extends in the second direction.

12. The planar antenna as claimed in claim 1, wherein said extension section of said second radiator arm extends in the first direction, and said second coupling section extends in the second direction.
